(19) United States
(12) Patent Application Publication
(10) Pub. No.: US 2009/0072532 A1
(43) Pub. Date: Mar. 19, 2009

(54) Terminations for high-pressure/high-temperature hoses

(76) Inventor: Keith Dixon-Roche, Northumberland (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/990,569

(22) PCT Filed: Aug. 16, 2006
(86) PCT No.: PCT/GB2006/003077

§ 371 Date: Feb. 15, 2008

(30) Foreign Application Priority Data
Aug. 16, 2005 (GB) 0516780.4

(51) Int. Cl. F16L 33/207

(52) U.S. Cl. 285/256

(57) ABSTRACT

A termination apparatus for use in providing a termination on a hose by crimping and a method of forming a termination. The apparatus includes a hose former adapted to be positioned at the hose end. The former has one or more, preferably annular, grooves, and a corresponding number of crimped rings crimped into the groove(s), so that the material of the hose is forced into a serpentine shape in cross-section.

The present invention relates to terminations for high-pressure/high temperature hoses and more particularly to crimped end fittings for such hoses.

Large bore high-pressure/high-temperature hose and pipe and terminations are normally affixed by means of an epoxy resin as crimping (the technology adopted for small bore hoses & pipes) has hitherto proven unsuccessful in demanding applications (fluctuating temperatures, pressure cycling, end load cycling, etc.).

However, the epoxy resins available today have limitations that would preclude their use above 120° C. in demanding applications. Furthermore, it is not yet possible to retro-fit an end termination except for the least demanding applications. And this technology has proven unreliable.

The problem is currently to find a retro-fitted crimped end fitting design that can support demanding applications, which would also be cheaper and quicker to assemble (in terms of man-hours) than today's inbuilt end terminations.

The conventional crimping method relies on gripping in line with the reinforcement, which results in a high crimp load, and/or damage to the grip surface and long end terminations. Furthermore, if the insert does begin to slide, there is little in the structure to prevent it from continuing to slip. The grip force in this design is established simply by multiplying the area of grip by the crimp load and the coefficient of friction.

It is therefore an object of the present invention to provide a method of providing a termination on a hose by means of crimping which overcomes or at least mitigates the above described problems.

It is a further object of the present invention to provide apparatus for providing a termination on a hose wherein the termination is crimped in position and a hose provided with such a crimped termination.

According to one aspect of the present invention there is provided a method of providing a termination on a hose by means of crimping comprising the steps of positioning a former at the hose end, the former having one or more annular grooves, and crimping a corresponding number of crimping rings into said annular groove (s) thus forcing the material of the hose between the former and the crimping rings into a serpentine shape in cross-section.

Preferably the method further comprises the step of inserting the former into the hose end.

Alternatively the method further comprises the step of mounting the former on the hose end.

Preferably the method further comprises the step of mounting a sleeve over the hose end and the former.

Advantageously, the sleeve is provided with one or more internal groove(s) which correspond to the crimping rings and the method includes the step of crimping the sleeve onto the hose end.

Conveniently the crimping rings are crimped in sequence from the inner ring remote from the hose end to the outer ring adjacent the hose end.

Preferably the inner ring is fully crimped and each outer ring is initially crimped by a lesser amount than the inner ring.

Advantageously each outer ring is initially crimped by around 30%.

Preferably also the method further comprises the step of crimping the outer rings by around a further 30% in a second crimping operation.

More preferably, the method further comprises the step of crimping the outer rings fully in a third crimping operation.

Advantageously, the method of providing a termination on a hose according to claim further comprises the step of calculating the amount of grip exerted on the hose by the crimping rings according to the formula:—

T₂=T₁*e^{μθ}

Where T₁ is the load on the hose as a result of internal pressure

e is an exponent
μ is the coefficient of friction between the hose and the crimping rings, and
θ is the angle of the slope of the sides of the crimping rings.

According to a further aspect of the present invention there is provided a termination apparatus for use in providing a termination on a hose by means of crimping, the apparatus comprising a hose former adapted to be positioned at the hose end, the insert having one or more annular grooves, and a corresponding number of crimped rings crimped into said groove(s), the arrangement being such that the material of the hose between the former and the crimping rings is forced into a serpentine shape in cross-section.

Advantageously the groove(s) are formed externally on the former.

Conveniently the former has an internal lateral passageway formed therein and the groove(s) are formed internally on the former.

Preferably a sleeve is mounted over the hose end and the former.

Preferably also the groove(s) of the former have a frustoconical profile.

Advantageously the slope of one side of the groove(s) is steeper than the other.

Conveniently the steeper side of the grooves is proximal the hose end.

Preferably the crimping rings have a frustoconical profile.

Preferably the slope of the sides of the crimping rings to the transverse axis of the hose is in the range 15°-50°.

More preferably the range is 20°-45°.

More preferably still the range is 25°-35°.

Preferably also the sleeve is provided with one or more internal groove(s) which correspond in use to the position of the crimping rings.

Advantageously the edges of the internal groove(s) of the sleeve are chamfered.

Conveniently the chamfer at the front edge of the groove(s) of the sleeve are shallower than at the back edge.

Preferably locking means are provided on the former and the sleeve to prevent relative lateral movement of the former and the sleeve.

More preferably the locking means comprises a detent on one of the former or the sleeve and a co-operating lug on the other.

According to a third aspect of the present invention there is provided a hose comprising a termination apparatus according to the second aspect of the present invention.

Typically, the hose contains circumferential reinforcement fibres or wires in a rubber or plastics matrix. The matrix may be stripped down in the termination area to expose the reinforcement before the insert and crimping ring(s) are positioned. The termination area may be expanded by use of a plug before inserting the former.

The present invention is based on forcing the reinforcement into deep grooves crimping not only on the surfaces in-line with the lay of the reinforcement, but also on vertical or near-vertical angled faces of deep crimping rings that will need to be assembled prior to assembly of the Sleeve. This approach increases the grip load by applying the formula T₂=T₁·e^{μθ} every time the reinforcement changes direction. The design in the drawings below provides a grip force considerably higher than can be expected from a conventional in-line configuration. Furthermore, the strain induced in the crimped sleeve using this approach is considerably less than would normally be required for such an end termination.

Embodiments of the present invention will now be described with reference to the accompanying drawings in which:—

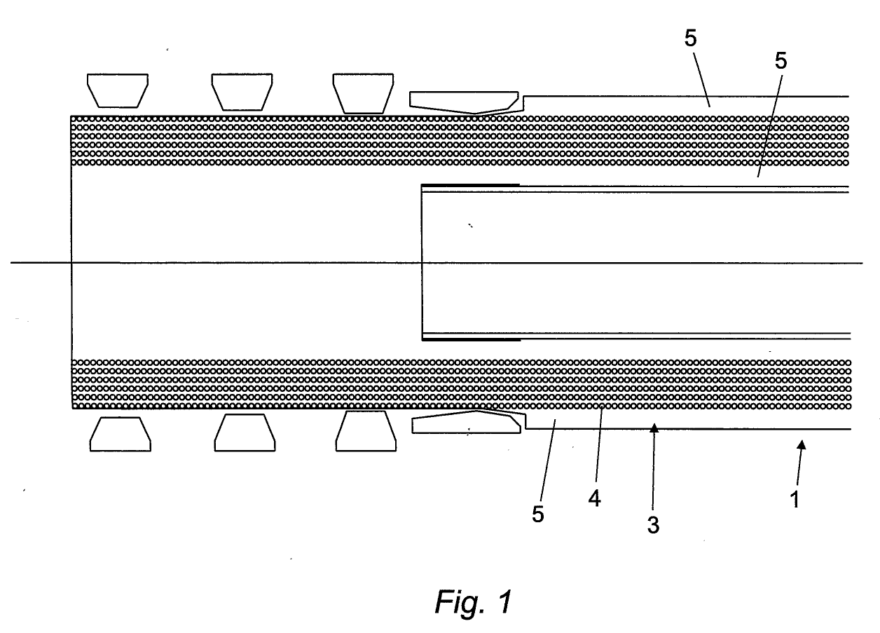

FIG. 1 is a cross-sectional view of a hose end with crimping rings applied;

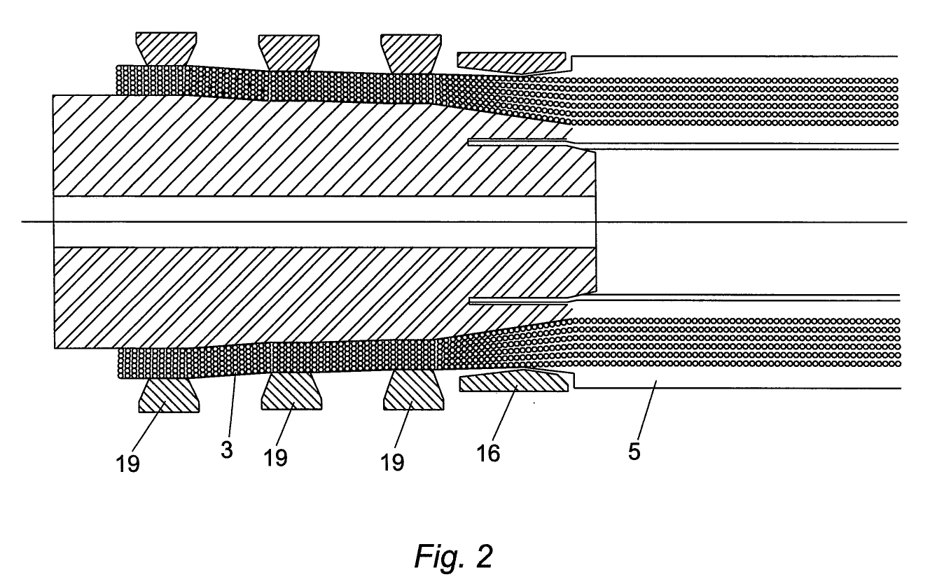

FIG. 2 is a cross sectional view of the hose end of FIG. 1 with a plug inserted to open out the hose end;

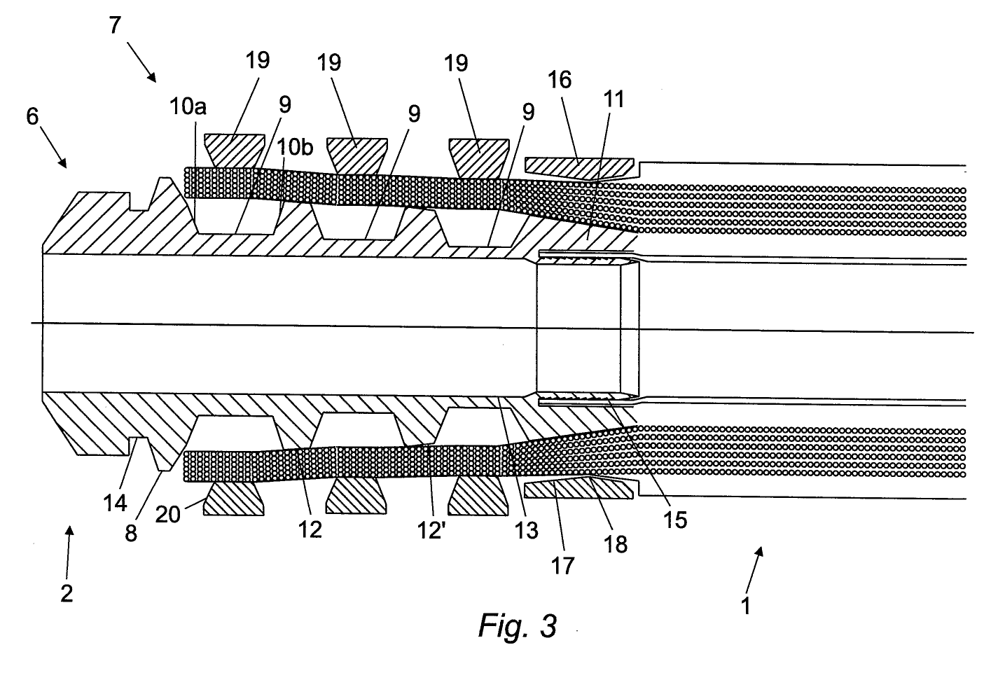

FIG. 3 is a cross sectional view of a termination apparatus according to one aspect of the present invention prior to crimping;

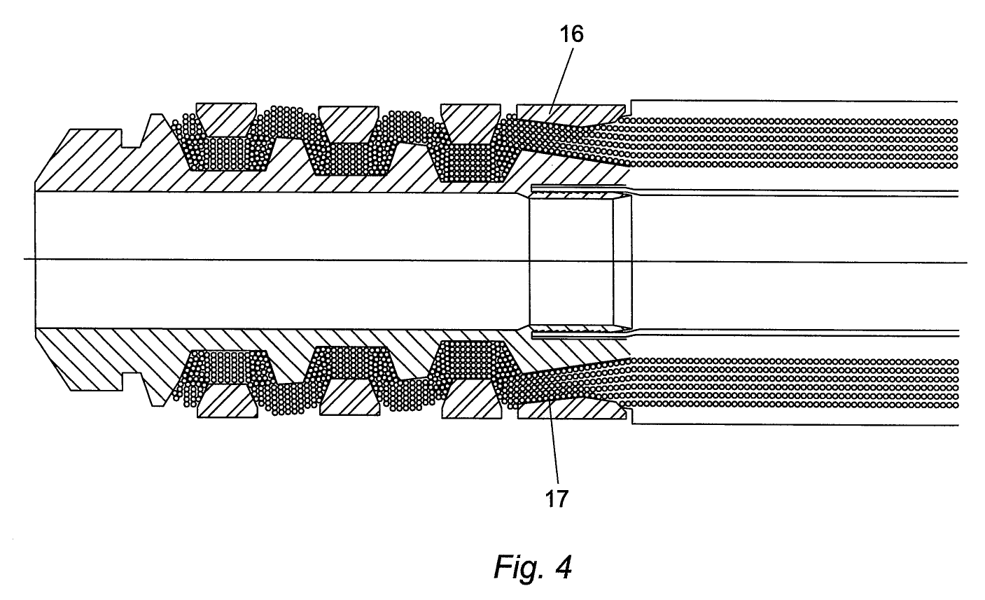

FIG. 4 is a cross sectional view of the apparatus of FIG. 3 following crimp ring activation;

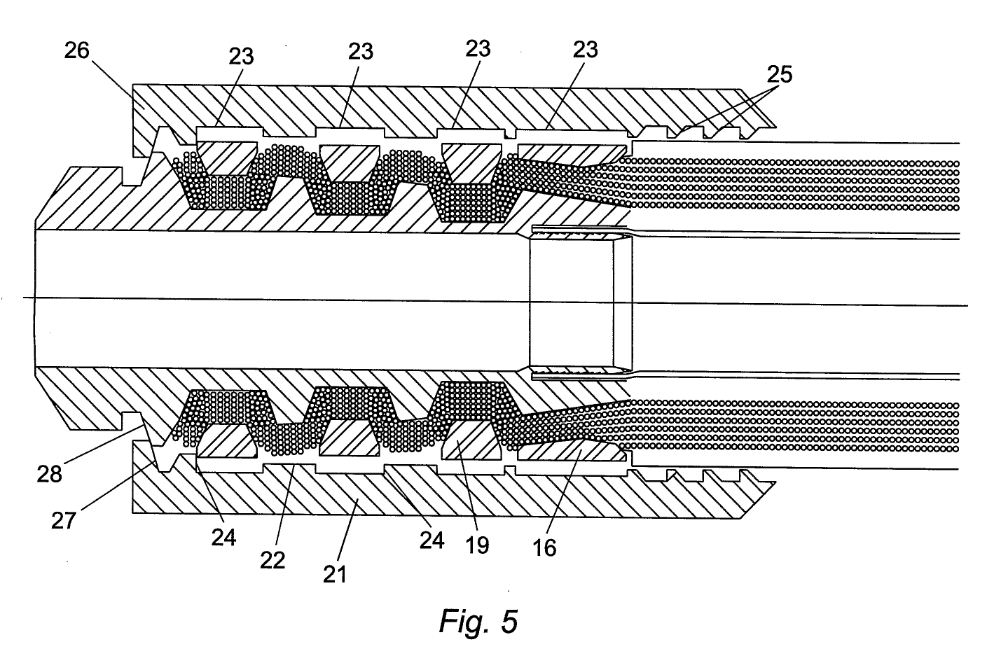

FIG. 5 is a cross sectional view of the apparatus of FIG. 4 with an external sleeve fitted around the crimping rings;

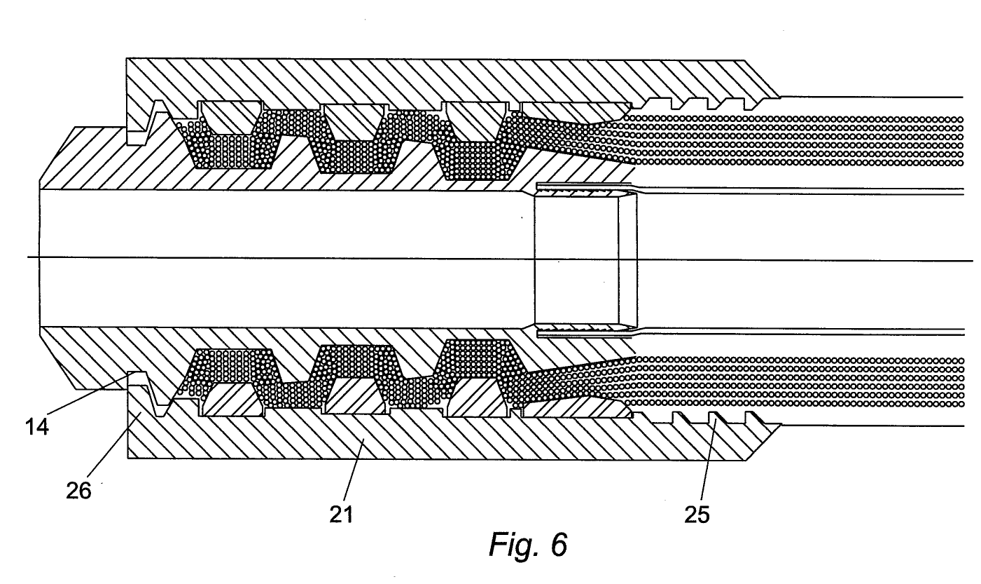

FIG. 6 is a cross sectional view of the apparatus of FIG. 5 following crimping of the sleeve;

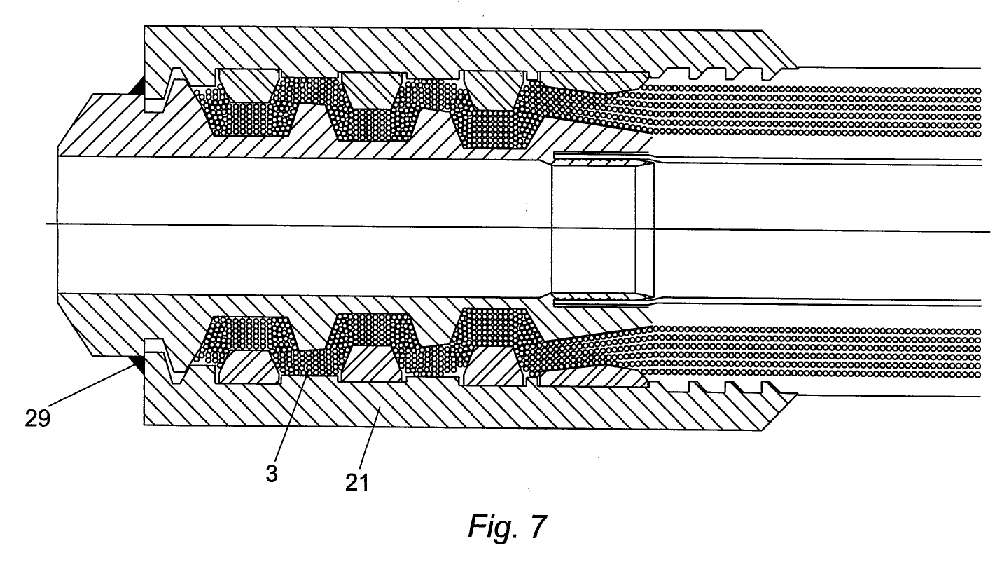

FIG. 7 is a cross sectional view of the crimped hose end termination of FIG. 6 with a seal weld between the insert and the sleeve;

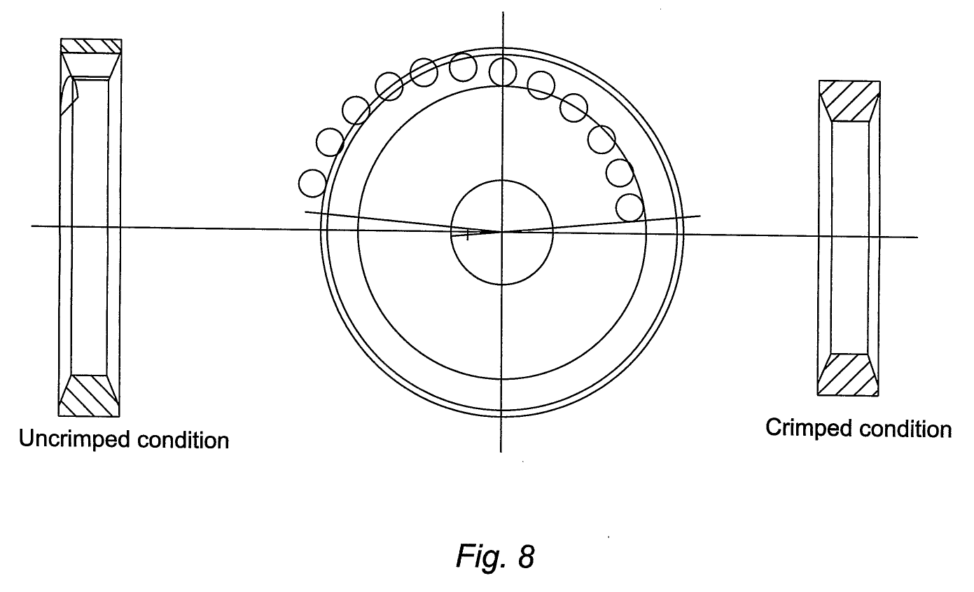

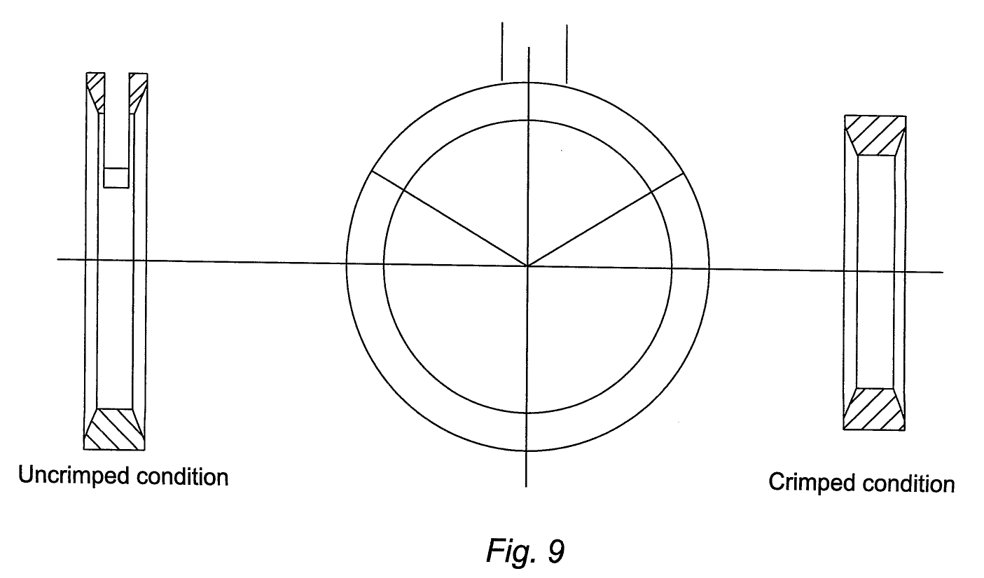

FIGS. 8 and 9 are schematic views of alternative forms of crimping rings;

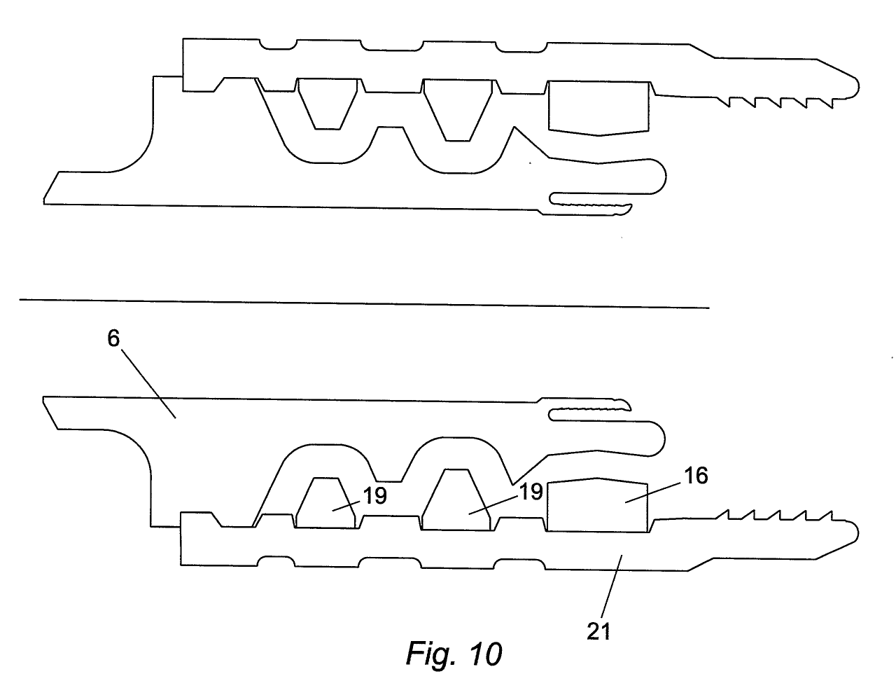

FIG. 10 is a cross-sectional view of a termination apparatus for a hose according to a second aspect of the present invention with the hose removed for clarity, and

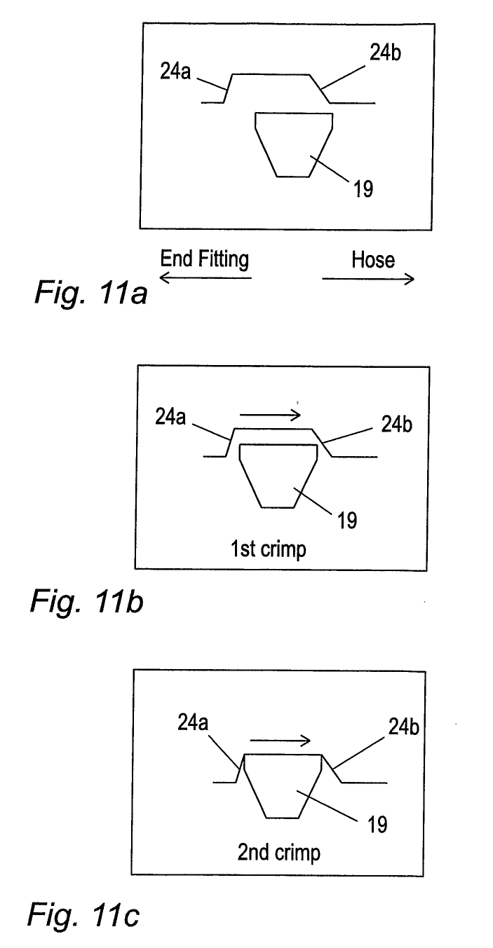

FIGS. 11A-11C are schematic views illustrating the relative position of the sleeve and the crimping rings during the crimping operation.

Turning now to the drawings, there is shown in FIG. 3 an end 7 of a large bore high-pressure/high temperature hose 1 to which a termination 2 (see FIG. 7) is required to be fitted. The hose as shown is formed of flexible steelcord 3 comprising thin strands of metal 4 extruded into a rubber sheath 5 in accordance with known techniques.

A hollow tubular profiled former 6 is inserted into the end of the hose. The former is preferably made of steel. The external surface 8 of the former is provided with a plurality of annular grooves 9 three of which are shown in FIG. 3. The annular grooves are shown as having different depths although it is to be understood that they may all share the same depth in some embodiments.

The sides 10 of the annular grooves are sloped inwards by about 15°-50°. Preferably the slope is around 20°-40° more preferably still 25°-35° as will be described further below. The slope of the front side 10a of the grooves may be the same as the slope of the rear side 10b of the grooves. Alternatively the slopes of the front and rear sides of the grooves may differ.

The outer diameter of the lower portion 11 of the former, i.e. remote from the hose end in use, decreases to allow the former to be pushed into position in the end of the hose.

The side 12 of the former between the first and second grooves 9 is parallel to the inner surface 13 of the former. The side of the former 12′ between the second and third grooves 9 tapers inwardly towards the third groove. It will be understood that the sides 12, 12′ of the former 6 may all be parallel to the inner surface 13 or may all taper or may provide a combination of parallel and tapering surfaces.

A detent 14 in the form of an annular groove is provided adjacent the end of the former extending from the hose end 7 as will be described further below.

The other end of the former 6 remote from the hose end 7 is provided with an annular location groove 15 which is coaxial with the former to enable the former to be securely received on the end of the rubber sheath 5 within the hose end.

In the present embodiment, four crimping rings 16, 19 are shown mounted over the hose end. Any number of rings may be used and the invention is not intended to be limited to any specific number of rings. The crimp rings shall preferably of solid construction, i.e. with no cuts, slots or incisions. In this embodiment, the inner most ring which is hereinafter called the nose ring 16, remote from the hose end 7 has a generally rectangular cross-section. The internal surface 17 of the ring tapers upwards from the extreme edges to meet in an apex 18 approximately at the centre of the surface as will be described further below.

The outer rings 19, three of which are shown in FIG. 3 have sides 20 which slope inwards forming an angle θ to the transverse axis of the hose end. The angle is preferably in the range 15°-50° and more preferably in the range 20°-45° and more preferably still in the range 25°-35°.

The outer rings 19 are shown in FIG. 3 as being substantially the same size but the size of the rings may vary from the ring adjacent the inner ring to the outermost ring.

FIG. 5 of the drawings shows a sleeve 21 mounted over the crimping rings 16, 19. The sleeve is formed of steel and is a generally hollow tubular body having an internal diameter slightly greater than the external diameter of the hose 1 or crimped rings to allow the sleeve to be received on the hose end 7 from either the hose end 7 or remote from the hose end 5.

The internal surface 22 of the sleeve (FIG. 5) is provided with a plurality of annular grooves 23 which correspond in number to the crimping rings 16, 19 provided in the end termination. The sides of the grooves 24 are shown in FIG. 5 as being substantially at right angles to the inner surface of the sleeve. In an alternative embodiment shown in FIGS. 10 and 11, the sides of the grooves are sloped to allow for movement during the crimping operation which is to be described below. In FIG. 11, the side 24a of the grooves of the sleeve closest to the hose end are provided with a steep chamfer to prevent snagging of the crimping rings on the sleeve. The other side 24b of the grooves, remote from the hose end are provided with a shallower sloping profile which allows for lateral growth of the crimping ring as the sleeve is compressed.

One or more annular protrusions 25 are provided on the inner surface of the sleeve remote from the hose end. The protrusions enable the sleeve to grip the outer surface of the hose when the sleeve is in position.

An inwardly projecting flange 26 is provided at the other end of the sleeve adjacent the hose end. The flange is dimensioned to be received within the detent 14 of the former to provide a locking means between the former and the sleeve. The lower surface 27 of the flange and the corresponding abutment surface 28 of the former may be sloped to provide gradual engagement between the former and the sleeve.

A method of fitting the hose end termination apparatus will now be described with reference to FIGS. 1 to 7 of the drawings

As shown in FIG. 1, when a termination according to the present invention is required to be crimped onto the end of a hose formed flexible steelcord, the hose end is firstly prepared by stripping the inner and outer rubber sheaths that protect the thin metal strands of the steelcord.

A plug may be inserted into the hose end to expand the hose end sufficiently to receive a termination if required and subsequently removed. The Former shall preferably be assembled without the need for prior deformation with a plug.

Turning now to FIG. 3, the plug is removed and the profiled former is inserted into the hose end. The taper on the outer surface of the lower portion 11 of the former 6 enables the former to be pushed into position within the hose 1. The former is inserted until the rubber sheath is fully seated in the annular location groove 15 of the former 6.

The crimp rings are then provided over the hose end. The number of outer crimp rings used corresponds to the number of annular grooves in the outer surface of the former. The nose ring 16 is positioned over the corresponding groove in the former. Each of the outer crimp rings 19 is then positioned over the hose end above the position of a corresponding groove in the outer surface of the former 6.

The nose ring is then crimped onto the hose by a known crimping apparatus. The apex 18 on the internal surface 17 of the nose ring functions to increase the coefficient of friction between the hose and the nose ring thereby providing a more secure fitting for the end termination 2.

The outer rings are then crimped onto the hose in sequence starting from the inner most ring adjacent the nose ring. In a preferred embodiment, the inner ring is initially crimped by about 30% and each of the remaining crimping rings are crimped sequentially by a similar amount. The inner most ring is then crimped by a further 30% followed by the remaining rings in sequence. Finally, the innermost ring is crimped by about a final 40% followed by the remaining crimping rings in sequence. This sequential and partial crimping operation serves to ensure correct alignment of the crimping rings 19 in the grooves 9 of the former 6 and also serves to accommodate any longitudinal expansion of the hose as it is gripped between the former and the crimping rings.

As the crimping rings are crimped into the grooves 9 on the former 6, the hose 1 is elastically deformed around the rings and generally takes up the shape of the grooves 9 as shown in FIG. 4. During deformation, the hose is forced into a substantially serpentine shape in cross-section.

The hose is deformed around the sloping sides 10a and 10b on the grooves 9 of the former and the sloping sides 20 of the crimping rings 19, the steep slopes of the grooves and the rings increase the grip load exerted on the hose by the rings in accordance with the formula:

T₂=T₁*e^{μθ}

Where T₁ is the load on the hose as a result of internal pressure;

e is an exponent;
μ is the coefficient of friction between the hose and the crimping rings, and
θ is the angle of the slope of the sides of the crimping rings to the transverse angle of the hose.

The sleeve 21 is then mounted over the hose end 7 until the internal grooves 23 of the sleeve correspond in position to the crimping rings 16, 19. In this position, the annular protrusions 25 at end of the sleeve remote from the hose end grip the outer rubber sheath 5 of the hose. The flange 26 at the other end of the sleeve 21 adjacent the hose end locates loosely in the annular detent 14 of the former to hold the sleeve in position prior to crimping.

The sleeve 21 is then crimped in position over the crimping rings as shown in FIG. 6. As the sleeve advances towards the rings, the rings 19 are located within the grooves 23 of the sleeve. FIGS. 11a-11c show the gradual engagement of the rings within the grooves where the sides 24 of the grooves are sloping with respect to the transverse axis of the hose.

The chamfered front side 24a of the grooves act as a location guide for the rings and ensure that the rings do not snag on the front edge of the grove during crimping of the sleeve which could affect the final position of the rings and the integrity of the connection.

The sloping back side 24b of the grooves functions to take up any lateral expansion of the rings caused during the crimping operation and this assists in providing a more secure termination 2 on the hose end 7.

As the sleeve 21 is crimped the lower surface 27 of the flange 26 rides up the abutment surface 28 of the detent 14 of the former and this securely locks the sleeve into engagement with the former such that neither can be removed from the hose end without the other.

Finally, a seal weld 29 is provided between the flange 26 of the sleeve and the outer lip of the detent 14 of the former to prevent ingress of moisture into the end termination.

Crimp rings shall preferably be of solid section, without cuts, slots or incisions. However, where the required deformation in the crimp ring induces excessive plastic strain in the steel material, a slot or incision may be cut into the ring section to permit greater deformation without inducing excessive strain. Examples of such slots or incisions are shown in FIGS. 8 and 9.

Modifications and improvements may be made to the foregoing example within the scope of the invention. For example, the crimp profile in the nose of the insert could be modified as shown in FIG. 10 to prevent it being pushed out during the initial crimp process. Furthermore, the profile of the grooves 9 of the former may be changed to provide a substantially curved surface such as shown in FIG. 10.

The abutment surfaces 27 and 28 of the sleeve and former may be parallel to minimise longitudinal movement of the sleeve during the crimping process.

The projections 25 used to grip the cover of the hose may be altered to be semi-circular or rectangular.

Whilst the invention has been described in relation to a terminal end fitting on a hose, it is to be understood that the terminal end fitting may equally be provided on other tubular members such as pipes.

Furthermore, the generally serpentine shape of the hose in cross section when crimped in position is understood to include any undulating form where the hose is deformed transversely along its length or part of its length in an alternating pattern of inward and outward deformations.

In a further embodiment of the invention, the crimping rings may be crimped fully in a single crimping operation. Additionally or alternatively, the crimping rings need not be sequentially crimped but may be crimped together or in any combination. Furthermore, the seal weld provided between the sleeve and the former may be replaced by expoxy resin or some other sealant injected between the sleeve and the former. The outer surface of the sleeve may be provided with one or more annular grooves which may be positioned in use between the crimping rings.

1. A method of providing a termination on a hose by means of crimping comprising the steps of positioning a former at the hose end, the former having one or more annular grooves, and crimping a corresponding number of crimping rings into said annular groove(s) thus forcing the material of the hose between the former and the crimping rings into a serpentine shape in cross-section.

2. A method of providing a termination on a hose according to claim 1, further comprising the step of inserting the former into the hose end.

3. A method of providing a termination on a hose according to claim 1, further comprising the step of mounting the former around the hose end.

4. A method of providing a termination on a hose according to, claim 1 comprising the further step of mounting a sleeve over the hose end and the former.

5. A method of providing a termination on a hose according to claim 4, wherein the sleeve is provided with one or more internal groove(s) which correspond to the crimping rings and the sleeve is crimped onto the hose end.

6. A method of providing a termination on a hose according to claim 1 wherein the crimping rings are crimped in sequence from the inner ring remote from the hose end to the outer ring adjacent the hose end.

7. A method of providing a termination on a hose according to claim 6, wherein the inner ring is fully crimped and each outer ring is initially crimped by a lesser amount than the inner ring.

8. A method of providing a termination on a hose according to claim 7, wherein each outer ring is initially crimped by around 30%.

9. A method of providing a termination on a hose according to claim 8, further comprising the step of crimping the outer rings by around a further 30% in a second crimping operation.

10. A method of providing a termination on a hose according to claim 9, further comprising the step of crimping the outer rings fully in a third crimping operation.

11. A method of providing a termination on a hose according to claim 1, wherein the amount of grip exerted on the hose by the crimping rings is calculated according to the formula:
T₂=T₁*e^{μθ}
Where T₁ is the load on the hose as a result of internal pressure e is an exponent μ is the coefficient of friction between the hose and the crimping rings, and θ is the angle of the slope of the sides of the crimping rings.

12. A termination apparatus for use in providing a termination on a hose by means of crimping, the apparatus comprising a hose former adapted to be positioned at the hose end, the former having one or more annular grooves, and a corresponding number of crimped rings crimped into said groove(s), the arrangement being such that the material of the hose between the former and the crimping rings is forced into a serpentine shape in cross-section.

13. A termination apparatus according to claim 12, wherein the groove(s) are formed externally on the former.

14. A termination apparatus according to claim 12, wherein the former has a longitudinal lateral passageway formed therein and the groove(s) are formed internally on the former.

15. A termination apparatus according to claim 12, wherein the groove(s) of the former have a frustoconical profile.

16. A termination apparatus according to claim 15, wherein the slope of one side of the groove(s) is steeper than the other.

17. A termination apparatus according to claim 16, wherein the steeper side of the grooves is proximal the hose end.

18. A termination apparatus according to claim 12, wherein the crimping rings have a frustoconical profile.

19. A termination apparatus according to claim 18, wherein the slope of the sides of the crimping rings to the transverse axis of the hose is in the range 15°-50°.

20. A termination apparatus according to claim 19, wherein the range is 20°-45°.

21. A termination apparatus according to claim 20, wherein the range is 25°-35°.

22. A termination apparatus according to claim 12, wherein a sleeve is mounted over the hose end and the former.

23. A termination apparatus according to claim 22, wherein the sleeve is provided with one or more internal groove(s) which correspond in use to the position of the crimping rings.

24. A termination apparatus according to claim 23, wherein the edges of the internal groove(s) of the sleeve are chamfered.

25. A termination apparatus according to claim 24, wherein the chamfer at the front edge of the groove(s) of the sleeve are shallower than at the back edge.

26. A termination apparatus according to claim 22, wherein locking means are provided on the former and the sleeve to prevent relative lateral movement of the former and the sleeve.

27. A termination apparatus according to claim 26, wherein the locking means comprises a detent on one of the former or the sleeve and a co-operating lug on the other.

28. A hose comprising a termination apparatus according to claim 12.

29. A method of providing a termination on a hose by means of crimping substantially as hereinbefore described with reference to and as shown in the accompanying figures.

30. (canceled)

31. (canceled)
